(19) United States
(12) Patent Application Publication
(10) Pub. No.: US 2007/0299746 A1
(43) Pub. Date: Dec. 27, 2007

(54) CONVERGED TOOL FOR SIMULATION AND ADAPTIVE OPERATIONS COMBINING IT INFRASTRUCTURE PERFORMANCE, QUALITY OF EXPERIENCE, AND FINANCE PARAMETERS

(75) Inventors: MICHAEL R. HALEY, SOUTH SALEM, NY (US); DINESH C. VERMA, MT. KISCO, NY (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/425,850

(22) Filed: Jun. 22, 2006

(51) Int. Cl. G06Q 10/00

(52) U.S. Cl. 705/28

(57) ABSTRACT

The present invention discloses a convergence tool for analyzing an information technology infrastructure that integrates network performance, quality of experience (QOE), and anticipated financial return parameters, which are interdependent on one another. One aspect of the invention includes a method including a step of identifying an information technology infrastructure configuration having an estimated subscriber load resulting from at least one service provided over the infrastructure. Performance metrics for the infrastructure can be computed based upon the subscriber load. Quality of experience metrics for subscribers receiving the service via the infrastructure can be determined based in part upon the computed performance metrics. Financial metrics can be calculated that are based in part upon an expected subscriber population, which is based in part upon the determined quality of experience metrics. The expected subscriber population can be used to adjust the estimated subscriber load.

### BACKGROUND

1. Field of the Invention

The present invention relates to the field of software tools for an information technology (IT) infrastructure and, more particularly, to a converged tool for simulation and adaptive operations combining IT infrastructure performance, quality of experience and finance metrics to generate simultaneous solutions for a plurality of interdependent models.

2. Description of the Related Art

Convergence has been defined as the coming together of two or more disparate disciplines or technologies. Digital networking technologies have converged to permit telecommunication service providers to provide Internet, television, and telephone services over a common network infrastructure. Providers that provide all three if these services are said to be performing a telecommunication Triple Play. In a Triple Play scenario, television services generally include Video on Demand (VOD) and/or Internet Protocol Television (IPTV) services. Telephone services can include wireless telephony services (sometimes called a Quadruple Play when wireless services are involved), Voice Over Internet Protocol (VOIP) services, and plain old telephone services (POTS). Internet services can include a variety of broadband services, such as Digital Subscriber Line (DSL) services, cable Internet services, and 3G wireless Internet services.

Providing Triple Play services can increase revenue by maximizing Information Technology (IT) infrastructure resources to deliver multiple fee based services to service subscribers. Additionally, providing multiple services can result in numerous combinative advantages. For example, studies have shown that customer loyalty or service retention increases as a number of services obtained from a single source increases. Additionally, any technological upgrades have synergetic effects, so that a single infrastructure upgrade can provide new subscriber benefits relating to multiple services. Further, maintenance and customer support activities tend to scale efficiently, permitting costs for these activities to decrease on a per customer and per service basis as a customer base and a service base increase.

Telecommunication service provides face high risk challenges when upgrading infrastructures as infrastructure upgrades need to provide Triple Play services for multiple cities can cost billions of dollars. Competition among a myriad of previously separate providers, including cable television companies, satellite television companies, wireless phone companies, and traditional phone companies, substantially increases the challenge of a successful telecommunication Triple Play. That is, each of these service providers has its own infrastructure base, which is capable of providing one or more of the services. The diversity of service providers leads to aggressive competition for subscribers, which strongly affects service rates that subscribers are willing to pay.

Another competitive factor in attracting and retaining a subscriber base is quality of experience (QOE). A service subscriber base is a key factor of infrastructure load. QOE as applied to delivered video can be seen by viewers as pixilated images, missing macro blocks, stalled motion, and unacceptably long times to change channels. QOE can also relate to fidelity of audio/video delivered to viewers. QOE for Web sites can relate to delay times in downloading graphics and/or flash material as well as response times in adjusting for user input. QOE varies depending on the service being measures. Technically, QOE problems relating to video can result from a failure to manage packet loss, audio/video synchronization, jitter, latency, and other factors. QOE factors can be exceptionally difficult for highly interactive services, such as interactive online games where even small delays can be unacceptable.

Still another factor complicating the Triple Play scene is time. Upgrading a telecommunication infrastructure is typically a staged process, where new capabilites are added to a sub area or sub network at each stage. The addition of new capabilites has to be timed with marketing efforts to attract a subscriber base. Providers who are first to market with a service have the highest likelihood of securing subscriber base before that base becomes entrenched with a competing provider. Too few subscribers can result in an adequate return in investment causing the provider to lose money as a result of an upgrade. Too many subscribers can result in an over tasked telecommunication infrastructure, which causes subscribers to have a low QOE. When a customer has a low QOE with a service that customer typically will avoid the associated service provider in the future.

To date, no converged simulation or adaptive operations tool exists that facilitate concurrent, solutions based upon infrastructure performance, QOE, and financial return metrics, Instead, different functionally independent tools are utilized to generate results for particular ones of these metrics. These results are heuristically combined by human agents who may estimate combined effects and interactions occurring between the values obtained from the tools. Alternatively, combined effects and interactions are ignored. Hence in a conventional solution, the interlocking nature and mathematical interdependencies between infrastructure performance, QOE, and financial metrics are not subject to a rigorous mathematical analysis. Consequently, decision makers using conventionally available tools and practices make corporate-level decisions regarding services and IT infrastructure utilization without explicitly knowing the tradeoffs between infrastructure performance, QOE of provided services, cost of providing one or more services, and expected investment returns.

### SUMMARY OF THE INVENTION

The present invention discloses a converged tool for information technology (IT) infrastructures that models infrastructure performances, quality of experience (QOE), and financial metrics in an interdependent fashion. Simultaneous model solutions can be performed so that variable changes made to any one of the models can automatically affect results of the other models. An authorized user of the converged tool can establish one or more constraints upon each of the models, where the only considered solutions are those satisfying the established constraints. Further, the user of the converged tool can establish different weights for each of the models so that one model can have a disproportionate affect upon simultaneous solutions. No known software tool integrates infrastructure performance, QOE, and finance variables in an interlocking fashion as described herein.

To utilize a mechanical analogy, the converged tool includes a set of meshed gears, each gear representing one of the three interdependent models. The models can include an infrastructure performance model, a QOE model, and a finance model. One or more constraints can be placed upon the tool, which can “rotate the gears” to determine one or more stable solutions that satisfy the constraints. A user of the converged tool can set any one of the gears as a master gear that drives output for the other gears. For example, a user can set a QOE gear as a master gear that drives infrastructure performance and financial return factors. Alternatively, setting either the infrastructure performance or finance gears as a master gear can result in losses and/or gains in QOE factors.

It should be appreciated that the converged tool can be integrated with various other software programs, which can include stand-alone programs capable of operating independent of the converged tool. These software programs can include an infrastructure or network simulator, a quality of experience program, and a financial forecasting and analysis software program. The integrated solution that includes the converged tool can conduct adaptive optimizations based upon results of component components. While the invention is capable of predictive optimization before deployment of an infrastructure, QOE, or financial change, the invention can also be used for adaptive operations in real-time or near real-time as part of a control loop to autonomically manage and optimize a running infrastructure system of IP-based services.

For example, the converged tool can automatically and dynamically modify parameters of the IT infrastructure component to increase infrastructure capacity to achieve a desired QOE. These adaptations can be constrained by infrastructure cost and required financial return parameters obtained from a financial return software component. The converged tool can also be used to forecast and/or plan IT infrastructure upgrades and service package rollouts.

The present invention can be implemented in accordance with numerous aspects consistent with material presented herein. For example, one aspect of the present invention can include a method for analyzing an IT infrastructure. The method can include a step of identifying an information technology infrastructure configuration having an estimated subscriber load resulting from at least one service provided over the infrastructure. Performance metrics for the infrastructure can be computed based upon the subscriber load. QOE metrics for subscribers receiving the service via the infrastructure can be determined based in part upon the computed performance metrics. Financial metrics can be calculated that are based in part upon an expected subscriber population, which is based in part upon the determined QOE metrics. The expected subscriber population can be used to adjust the estimated subscriber load.

Another aspect of the present invention can include a software method for analyzing an IT infrastructure. The software method can include a step of developing a performance model based upon an identified information technology infrastructure and an identified load. A QOE model can also be developed, where at least one formula used to construct the QOE model is a function of a service delivered to at least one subscriber via the infrastructure operating under the identified load. Metrics from the performance model can be used to solve the QOE formula. A finance model can also be developed that is based upon subscriber population for the service. The finance model can adjust the subscriber population in accordance with a blocking probability, which is dependent upon QOE metrics generated by QOE model. The blocking probability can be a probability that a service will be blocked due to a contention for resources. Constraints can be identified for each of the models. At least one solution can be automatically determined that concurrently satisfies the identified constraints.

Still another aspect of the present invention can include a converged tool for analyzing an information technology infrastructure. The tool can include an infrastructure performance component, a QOE component, and a finance component. The performance component can compute performance metrics experienced for an identified information technology infrastructure that is operating under an identified load. The QOE component can determine QOE metrics experienced by subscribers of the identified service provided over the information technology infrastructure based at least in part upon the computed performance metrics. The finance component can calculate financial metrics based in part upon a subscriber population that varies in accordance with the QOE metrics. The identified load can be dynamically adjusted in accordance with the subscriber population.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

In this invention, the term network is used as a generic reference to an infrastructure of a telecommunication service provider. Accordingly, the term network in this invention refers to the routers, switches, communication links and other devices used to provide connectivity between computing devices. The computing infrastructure can include end-points of communication (e.g., servers, video head-ends, application servers, etc.) as well as intermediate points of communications often present in network data centers (e.g., proxy servers, caches, advertisement insertion devices, etc.). Converged tools for an IT infrastructure and/or “network” thus defined refer to tools that compute an amount of computing resources need at various locations in a telecommunication infrastructure, as well as the bandwidth of communication links required within the telecommunication infrastructure.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a converged tool that integrates performance metrics, QOE metrics, and financial metrics for simulations and adaptive operations of an IT infrastructure in accordance with an embodiment of the inventive arrangements disclosed herein.

FIG. 2 is a schematic diagram of an infrastructure system that integrates infrastructure performance, quality of experience (QOE), and financial constraints in accordance with an embodiment of the inventive arrangements disclosed herein.

FIG. 3 shows an interface for setting constraints of a converged tool in accordance with an embodiment of the inventive arrangements disclosed herein.

FIG. 4 shows an interface for presenting solutions based upon infrastructure performance, QOE, and financial constraints in accordance with an embodiment of the invention arrangements disclosed herein.

FIG. 5 is a flow chart of a method for developing stable solutions using a converged tool in accordance with an embodiment of the inventive arrangements disclosed herein.

FIG. 6 is a flow chart of a method where a service agent can configure a converged tool in accordance with an embodiment of the inventive arrangements disclosed herein.

### DETAILED DESCRIPTION OF THE INVENTION

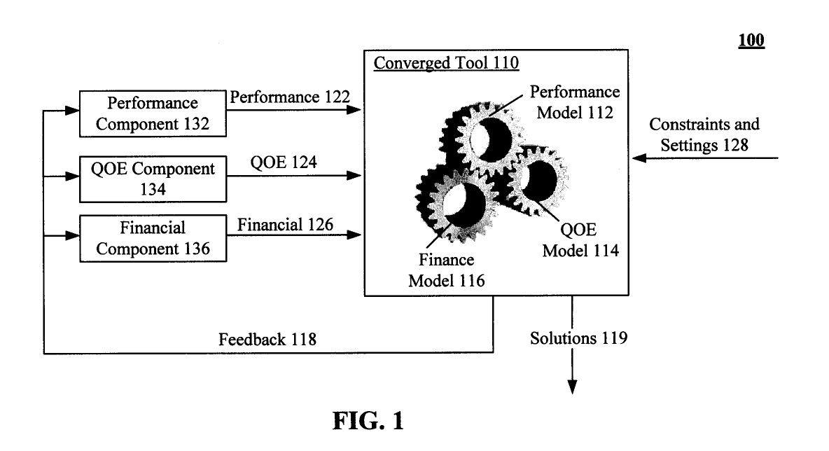

FIG. 1 is a schematic diagram of a system 100 including a converged tool 110 that integrates performance metrics 122, QOE metrics 124, and financial metrics 126 in accordance with an embodiment of the invention arrangements disclosed herein.

The converged tool 110 can include an infrastructure performance model 112, a QOE model 114, and a finance model 116, which are interrelated to each other. That is, changes made to one of the models 112-116 can have a mathematical effect on the other models 112-116. Concurrent solutions can be performed for the models 112-116, which can provide one or more stable results or solutions 119. Users can input constraints, adjustments, and other user designed settings 128 into the converged tool 110. for example, a user can designate a mathematical algorithm that is to be used to calculate a QOE for a given service. Different services provided via the IT infrastructure can be associated wit different QOE algorithms and values.

To utilize a mechanical analog, the models 112-116 function as a set of meshed gear linked to the other models 112-116. A user of the converged tool 110 can interactively select one of the models 112-116 as a “master gear” that drives results of the system 100. Thus, a user can make adjustments to a selected model 112-116 and can dynamically receive feedback showing the affect of the adjustments on other models 112-116.

In one example, a user can perform adjustments on the QOE model 114, which can alter states of the performance model 112 and the finance model 116. For instance, if an adjustment is made for an increased QOE in the QOE model 114, more infrastructure resources of a fixed information technology (IT) infrastructure can be consumed, which alters a load on the infrastructure, which can result in lower performance metrics 122. Additionally, an increase in QOE can lower a subscriber blocking probability can be a probability that a service will be blocked due to a contention for infrastructure resources. A low blocking probability and a high customer satisfaction level can result in an increased subscriber population, which increases revenue derived from subscribers, as calculated by the finance model 116. An increased subscriber population, however, can also increase subscriber load, which can degrade performance metrics 122. When performance metrics 122 degrade beyond a certain level, it is no longer possible to achieve a desired QOE without upgrading the IT infrastructure to improve performance metrics 122 to a level to achieve target QOE metrics. The finance model 116 can dynamically balance increased revenues for a service against an increased infrastructure cost.

The above example emphasizes that each of the models 112-116 are interdependent. When any of the metrics 122-126 used by one or more of the models 112-116 change, other changes can result. Feedback 118 shows that results from the converged tool 110 can be fed back into the components 132-136 that generate the metrics 122-126.

Components 132-136 can include a performance component 132, a QOE component 134 and a finance component 136, which generate performance metrics 122, QOE metrics 124, and financial metrics 126, respectively. Each of the components 132-136 can be a standalone program that interfaces with the converged tool 110 can be a software module integrated with the converged tool 110.

In one embodiment, the converged tool 110 can be used to forecast values of a simulated IT infrastructure. The converged tool 110 can also be used for dynamically analyzing, adjusting, and planning within an operational environment, such as an autonomic computing environment. For example, the converged tool 110 can be used to selectively and dynamically adjust a QOE for one service in real-time or near real-time to ensure that performance metrics 122 of an operational system stay within previously established boundaries. In another example, the converged tool and/or can suggest infrastructure upgrades within financial constraints imposed by the financial model 116 to achieve a desired QOE based upon real-time, historic, or estimated infrastructure metrics.

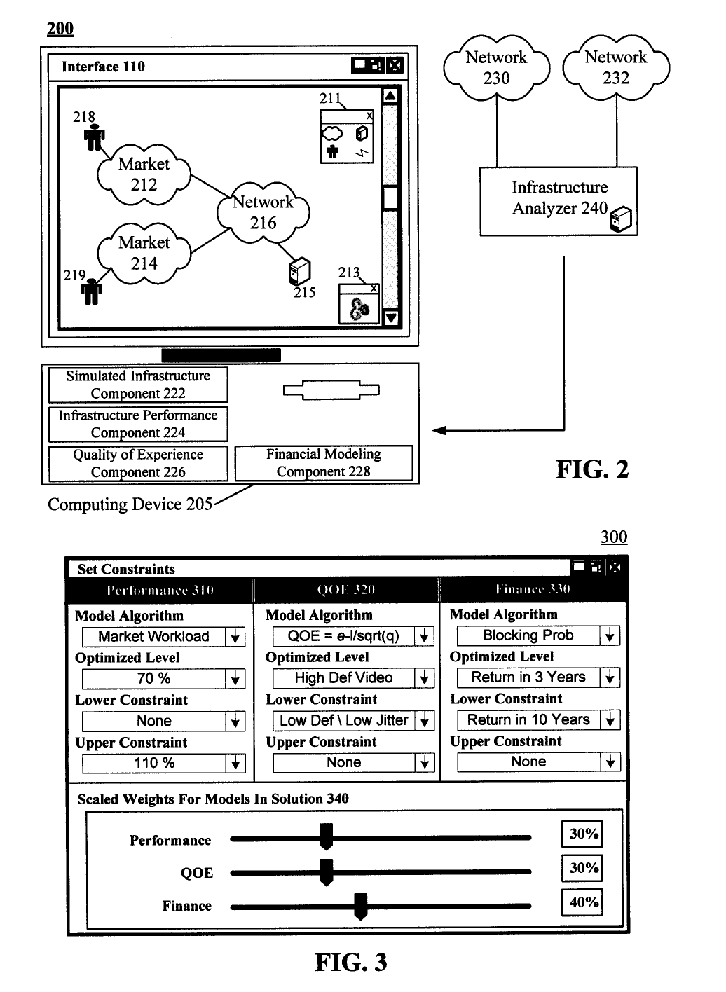

FIG. 2 is a schematic diagram of an infrastructure system 200 that integrates infrastructure performance, QOE, and financial constraints in accordance with an embodiment of the inventive arrangements disclosed herein. System 200 can represent one contemplated implementation for system 100. It should be appreciated that system 100 is a flexible system designed to be utilized for any IT infrastructure and is not to be construed as limited to details expressed in system 200.

System 200 can include a computing device 205 having a simulated infrastructure component 222, an infrastructure performance component 224, a QOE component 226, and a financial modeling component 228.

Computing device 205 can represent a standalone computing device or a series of communicatively linked and cooperating computing devices. Computing device 205 can, for example, include a desktop computer, a server, a cluster of services, a group of cooperating network elements and/or network devices, a virtual machine or virtual computing environment formed from a variety of allocated computing resources, and the like. Similarly, each of the components 222-228 can be implemented as stand-alone software applications and/or as cooperating software modules that form an integrated software solution.

The simulated infrastructure component 222 can be any IT infrastructure simulation tool. The simulated infrastructure component 222 can specify components that together are arranged to form an IT infrastructure. The simulated infrastructure component 222 can specify the quantity of computing resources available at different points within the IT infrastructure. The simulated infrastructure can provide at least one service to subscribers communicatively linked to the simulated infrastructure at designated connection points. Services can include, but are not limited to, VOD services, IPTV service, Internet services, phone services, wireless services, and the like. Different services can place different loads on a system and can have different performance requirements.

In one embodiment, component 222 can use a baseline model that represents an existing telecommunication infrastructure. This infrastructure information and accurate usage and performance metrics for the same can be automatically obtained using analysis tools. For example, infrastructure analyzer 240 can analyze network 230 and network 232 metrics which can be imported to the simulated infrastructure component 222 and used during simulations. The simulations can be used for planning and forecasting purposes and/or for adapting an operational environment.

In yet another embodiment, the simulated infrastructure component 222 can build a model of an infrastructure as a set of analytic equations that characterize the resulting capacity, throughout, and reliability characteristics of the infrastructure. Such analytic equations can be derived from queuing models used to represent devices in the simulated infrastructure.

The simulated infrastructure component 222 can combine different infrastructure assets, such as a coaxial infrastructure, a fiber infrastructure, a twisted pair infrastructure, and wireless components. Hybrid infrastructures are common for service providers, which have acquired one or more competing companies and their associated infrastructures. The simulated infrastructure component 222 can also combine computing infrastructure components at different points in the infrastructure, such as the number of video head-ends, the number of video-on-demand servers, the numbers of proxy servers, and the like. The simulated infrastructure component 222 can further suggest an upgrade pathway that combines the assets of the hybrid infrastructures to minimize overall costs.

The performance component 224 can be configured to compute performance characteristics of a simulated infrastructure. Performance characteristics can include delay occurring between a subscriber 218 or 219 and a server 215, transmission errors, and the like. Components 222 and 224 can be combined into a single infrastructure simulation tool, shown by interface 210.

Using interface 210, a series of graphical tools 211 can be placed on a canvas to form a simulated infrastructure. Different levels of granularity or abstraction can be presented. At high granularity level, a service server 215 linked to a network 216 can provide a service to market 212 and market 214. Multiple service subscribers, such as subscriber 218 and subscriber 219 can be members of the markets 212 and/or 214. The performance component 224 can determine jitter, packet delay, and other performance factors experienced by subscriber 218 and/or 219, by market 212 and/or 214, and by service subscribers in general.

Interface 210 can also include user customizable 213, which can affect load on the simulated network and resulting network characteristics. For example, the constraints 213 can include constraints for infrastructure capacity, QOE of a simulated service, and financial return data. Each of the constraints 213 can be dependent on one another.

It should be appreciated that numerous software tools exist simulating infrastructures and for determining performance characteristics of these infrastructures. In one embodiment, components 222 and 224 can be formed in part using the Telecom Web Services Toolkit and/or the Teleprocessing Network Simulator (TPNS) by International Business Machines (IBM) of Armonk, N.Y. The invention is not limited in this regard, however, and other simulation tools and technologies, such as OPNET based simulators, Ns-2 based simulators, GloMoSim base simulators, SemSim based simulators, and the like are contemplated for components 222-224.

QOE component 226 can be configured to determine a QOE for a service that is provided to different subscribers, sets of subscribers, or markets based at least in part upon subscriber location and infrastructure configuration elements. Many standards and tools exist for predicting a QOE for a provided telecommunication service. For example, the International Telecommunications Union (ITU) has proposed standards for delivering VOD, such as ITU-R B.500. Additionally, many commercial products exist for determining QOE values, such as Agilent's N2× QOE tool.

Regardless of technologies used by QOE component 226, a QOE of a subscriber in any market can be determined as a function of performance characteristics (obtained from component 224) a link between the market and the server from which service is received and as function of a load upon a server. In general, if a market is served by k servers (1, . . . k), the QOE can be estimated as an amount of time needed for a service to begin an amount of errors that can be estimated from that site.

The QOE can be estimated by a variety of functions. For example, a formula for UDP oriented traffic using RTP type flow control can be QOE=e^{-1/sqrt(d)}, where d is a delay between a market and a server, and 1 is the loss rate. Of course, other formulas depicting the QOE using other types of low control and based upon other services can be incorporated into the QOE component 226.

The financial modeling component 228 is configured to predict an impact for a QOE on an expected subscriber population, which affects a Return on Investment (ROI) since ROI is a function of cost of service and a number of service subscribers. The mapping from QOE to the financial workload of subscriber can be computed by a utility function model, such as one involving a blocking probability of subscribers on a market due to a shift in the QOE. A high QOE will indicate a low blocking probably or subscriber loss rate. In fact, a high QOE can be linked to a positive subscriber growth. A low QOE can result in a high blocking rate, which can decrease a subscriber base.

In one embodiment, the blocking probability can be quantified by means of the equation:

blocking probability=QOE/(QOE+e^{(C1-C2*QOE)})

where C1 and C2 are constants of the model that can be adjusted to help fit the blocking probability function to a desired curve, such as one based upon real world consumer data.

It should be appreciated that a complex part of constructing an integrated solution incorporating factors and constraints of components 222-228 relates to the fact that the components are interrelated. That is, blocking probability can be a function of QOE, which is determined by a load from each market, which is in turn determined by the blocking probability. Thus, instead of any of the computations being simple linear equations, a number of concurrent solutions based upon interrelated models must be determined. System 200 focuses upon determining one or more stable solutions that simultaneously satisfies an infrastructure performance model, a QOE model, and finance model.

FIG. 3 shows an interface 300 for setting constraints of a converged tool in accordance with an embodiment of the inventive arrangements disclosed herein. Interface 300 can be implemented in the context of system 100, system 200, or in the context of any other system that integrates metrics from a performance model, a QOE model, and a finance model. Each of the models can be associated with one or more user established constraints.

Interface 300 can include a performance section 310, a QOE section 320, and a finance section 330. Each section 310, 320 and 330 can specify an algorithm used for constructing a model, upper constraints, lower constraints, optimal values, and the like. Each of these sections 310, 320 and 330 can be configurable. For instance, an authorized user can replace a model algorithm with a different selectable algorithm or with a user developed or imported algorithm.

In one embodiment, the performance section 310 can specify a market workload algorithm. The model can be abstracted to a market level, where the algorithm determines performance characteristics (delay and loss rate) experienced by a packet as it traverses a network from a given market to a given server and back. For example, if there are K markets and M servers, a workload, W, from each market can be characterized as W(i) through W(K). The performance section 310 can set an optimized level at seventy percent, an upper constraint at one hundred and ten percent, and can have no lower constraint.

The QOE section 320 can set an optimized level for high definition video, a lower constraint for low definition with low jitter, and can have no upper constraint. Additionally, a model algorithm for QOE can be set to a formula for UDP oriented traffic using RTP type flow control. For example, the QOE algorithm can be QOE=e−1/sqrt(d), where d is the delay between the market and the server and 1 is the loss rate. Of course, other algorithms known in the art can be selected in section 320.

The finance section 330 can be set for an optimized a ROI of three years, and a lower ROI of ten years with no upper constraint for a ROI. The algorithm for computing financial return can include a blocking probably calculation, which alters a subscriber population based upon QOE.

Further, interface 300 can include a weighting section 340 that permits a user to emphasize or weigh a relative effect of each of the models on concurrent solutions. Using section 340, a weight of thirty percent can be set for both the performance and QOE models and a weight of forty percent can be set for the finance model. Accordingly, solutions can be selected to emphasize financial returns over QOE and performance.

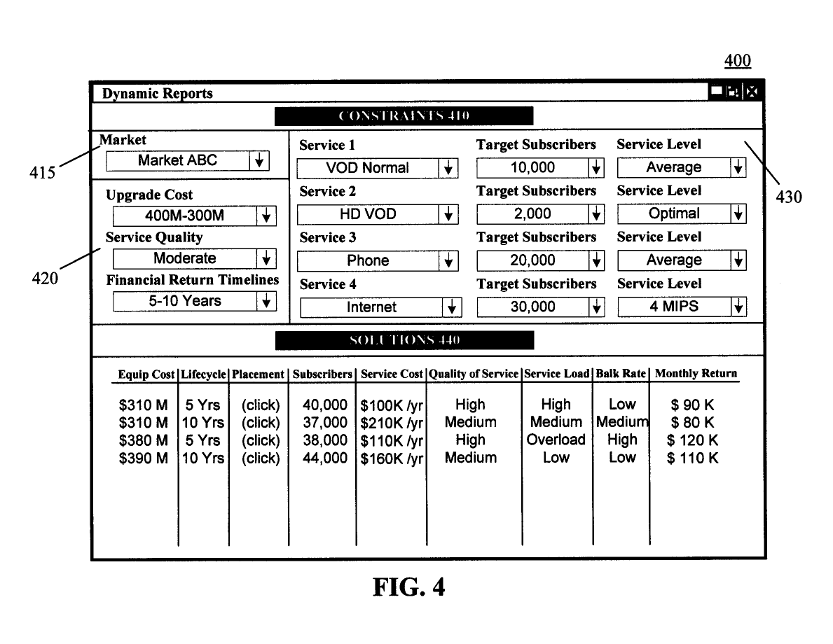

FIG. 4 shows an interface 400 for processing solutions based upon infrastructure performance, QOE, and financial constraints in accordance with an embodiment of the inventive arrangements disclosed herein. Interface 400 can be an interface used in the context of system 100, 200, or other similar system. Additionally, interface 400 and options presented with it can be constrained and/or combined with other constraints, such as those specified in interface 300. In another embodiment, interface 400 can function within a system not having any other previously established constraints.

Interface 400 can include a solution constraints section 410 and a solution section 440. Section 410 can include a market section 415, interrelated constraint section 420, and a service constraint section 430. Market section 425 can be used to specify one or more markets for which constrained solutions are to be provided. A market selected in section 415 can represent a subscriber population and a sub network over which one or more services are provided. Markets can be defined by an infrastructure simulation tool, such as simulated infrastructure component 222.

Section 420 can include adjustable parameters related to infrastructure capacity or performance characteristics, QOE characteristics, and financial characteristics. Each of the parameters in section 420 can be related to each other and to interdependent model solutions in some fashion. Particular ones of the parameters of section 420 can relate to a infrastructure performance model, a QOE model, and a finance model. Each of the parameters of section 420 can affect variables of multiple models.

As shown in section 420, a network upgrade cost parameter can be set for costs between $400 million and $300 million. These costs can be allocated to infrastructure components used to upgrade an infrastructure serving Market ABC (from section 415). A service quality parameter can target a moderate quality of service. The financial returns timelines parameters can indicate that an infrastructure upgrade investment is to be recovered within four years.

The service section 430 can specify one or more services, target subscriber level, and expected service level for the service. Multiple services can be specified in section 430, each of which impacts a subscriber load on an IT infrastructure. Although four services are shown in section 430, any number of services can be specified.

In section 430, a standard definition version of a VOD service can be provided to 10,000 subscribers at an average service level. A high definition version of the VOD service can be provided to 2,000 subscribers at an optimal service level. A phone service can be provided to 20,000 subscribers at an average service level. Finally, a broadband internet service ac be provided to 30,000 subscribers with an average service level of 4 MPS.

Solutions section 440 can provide one or more solutions that concurrently satisfy the constraints established in section 410. Each of the solutions can consist of a discrete set of attributes, such as equipment cost, an expected upgrade lifecycle, a proposed network configuration, an number of subscribers, service costs, a quality of service, a service load on the infrastructure, a blocking rate, and expected monthly revenue for the specified services. Clicking on the attribute for the proposed infrastructure configuration can bring up an infrastructure simulation tool and suggested placements of upgraded infrastructure components. Selecting other report attribute can present details showing how the selected attribute was calculated,

It should be noted that parameters presented in the solutions section 440 can be customized by an authorized user. Further, the solutions can be automatically adjusted when weights applied to underlying models (such as weights applied in section 340) are altered.

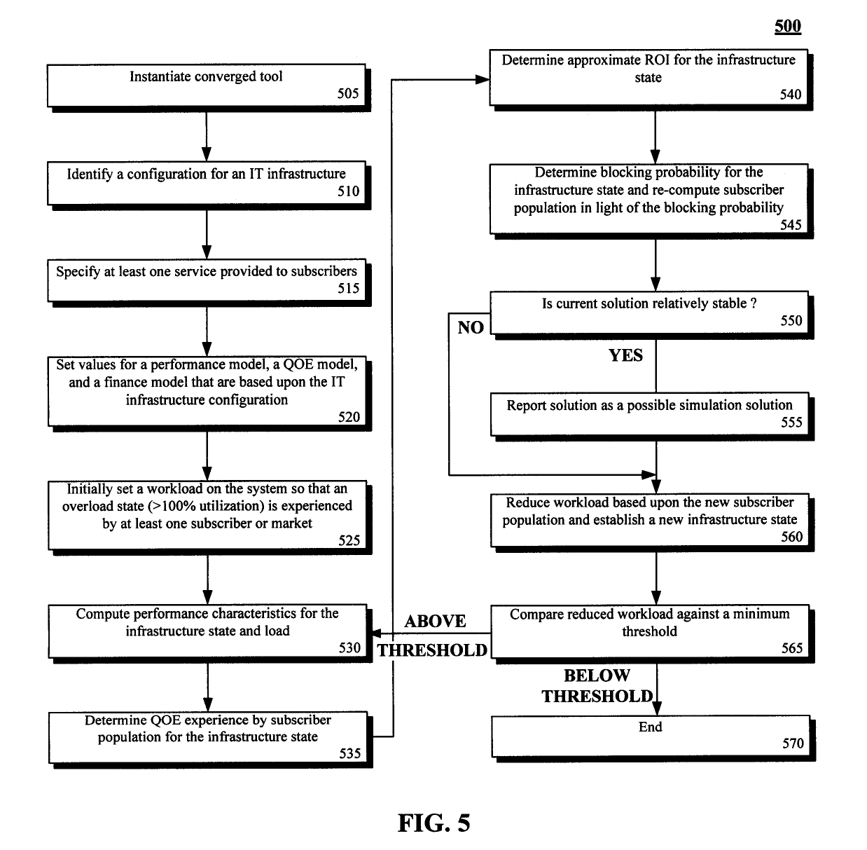

FIG. 5 is a flow chart of a method 500 for developing stable solutions using a converged tool in accordance with an embodiment of the inventive arrangements disclosed herein. The method 500 can be performed in the context of a system 100 or a system 200.

Method 500 can begin in step 505, where a converged tool can be instantiated, In step 510, a configuration for an IT infrastructure can be identified. For example, a graphical network simulation tool can be used to construct a simulated IT infrastructure. The simulation tool can be designed to be viewed/modified at any number of granularities, including a network/market granularity level, a network/subscriber granularity level, and a network/service granularity level. Information from lower level granularity levels can be aggregated in the higher levels. In one embodiment, network configuration information related to an existing IT infrastructure can be imported as a foundation for a simulated IT infrastructure boundaries.

In step 520, values for a parameter model, a QOE model, and a financial planning model can be set. These models can be interdependent on each other. User configurable parameters can adjust algorithms used, relative model weights, target threshold, and solution boundaries.

In step 525, a simulated workload or subscriber load can be set so that the system begins in an overload state. In this state, at least one subscriber, set of subscribers, or market can utilize an IT infrastructure at a greater than one hundred percent capacity. Starting with a fully utilized infrastructure permits a maximum utilization of deployed resources and a maximum return on an investment. In step 530, infrastructure characteristics can be computed for the infrastructure state. In step 535, QOE values can be determined for the subscriber population for the infrastructure state. In step 540, ana approximate ROI can be computed for the infrastructure state.

In step 545, a blocking probability can be determined for the infrastructure state. It can be assumed that since the infrastructure is initially overloaded, QOE experience by a portion of the subscribers will be relatively low causing the blocking probability based upon low QOE to be relatively high. A subscriber population can be recomputed in light of the blocking probability.

In one embodiment, an adaptation of the Newton-Raphson method for solving numeric equations can be used to concurrently solve the infrastructure performance, QOE, and ROI models. In the adaptation, a solution can be adopted that spans infrastructure capacity planning, financial models, and QOE. The invention is not to be construed as limited in this regard, however, and other mathematical techniques and methods can be utiltized.

In step 550, a determination can be made as to whether the solution is relatively stable. If so, the method can proceed to step 555, where the solution can be reported as a possible simulation solution. Otherwise, the method can proceed from step 550 to step 560, where workload can be reduced based upon the new subscriber population. A new infrastructure state can be computed for this new subscriber population and related load. In step 565, the reduced workload can be compared against a minimum workload threshold. If the workload is above the theshold, the method can loop from step 565 to step 530, where infrastructure performance characteristics, QOE values, and ROI values can be computed for the new infrastructure state. If the workload is below the minimum theshold, the method can be end at step 570.

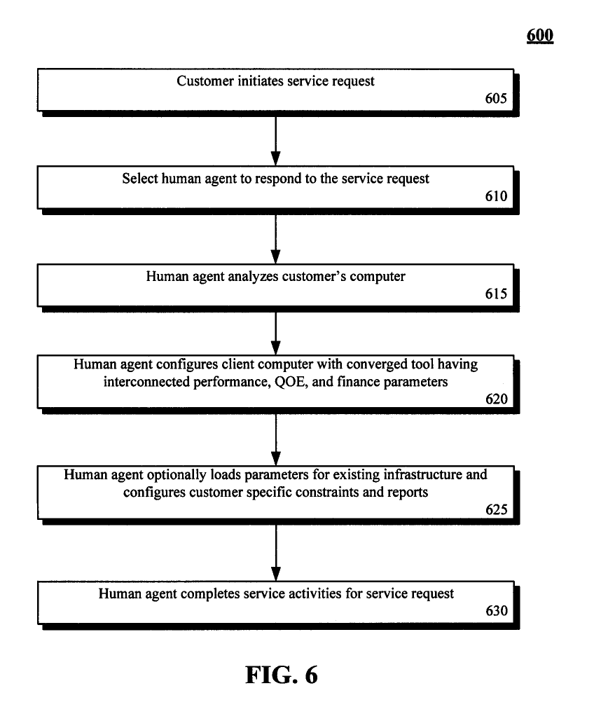

FIG. 6 is a flow chart of a method 600 where a service agent can configures a converged tool accordance with an embodiment of the inventive arrangements disclosed herein. Method 600 can be performed in the context of system 100, a system 200 and/or method 500.

Method 600 can begin in step 605, when a customer initiates a service request. The service request can be a request for a service agent to establish a converged tool having interdependent performance, QOE, and ROI parameters.

In step 610, a human agent can be selected to respond to the service request. In step 615, the human agent can analyze a customer's current system and can develop a solution. The solution can result in a system 200, or any system that performs the steps of method 500.

In step 620, the human agent can configure the customer's system so that a converged tool has interconnected performance, QOE, and ROI parameters. In step 625, the human agent can optionally configure customer specific constraints and reports. The human agent can perform steps 620 and 625 and/or can configure a computing device of the customer in a manner that the customer or clients of the customer can perform steps 620 and 625 using the configure system in the future. For example, the service agent can load and configure software and hardware so that client devices will automatically be able to simulate IT infrastructures as described herein. In step 630, the human agent can complete the service activities.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

An embodiment of the invention can link the integrated converged tool with online network monitoring systems to provide a continuously planning module for telecommunication services. In such an embodiment, a network monitoring system can collect statistics of requests received from various sources, an amount of bandwidth used at different points in the network, an amount of computing resources used at different points in the network, and the origination points of requests in the network. The collected statistics can be analyzed to determine a distribution of users into several geographies and to estimate network capacity. The analyzed information can be provided to the converged tool. The converged tool can then predict when the existing capacity can be expected to run out, and can recommend suitable infrastructure upgrades that are required for continued operation of the system at desired QOE levels. In another alternative embodiment, the converged tool can be linked to a resource provisioning system so that different points in the network can be provisioned to be upgraded with more capacity automatically as a need for additional capacity operationally emerges, as automatically determined by algorithms of the converged tool.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for analyzing an information technology infrastructure comprising:
identifying an information technology infrastructure configuration having an estimated subscriber load resulting from at least one service provided over the infrastructure;
computing performance metrics for the infrastructure based upon the estimated subscriber load;
determining quality of experience metrics for subscribers receiving the at least one service via the infrastructure based in part upon the computed performance metrics; and
calculating financial metrics based in part upon an expected subscriber population, which is based in part upon the determined quality of experience metrics, wherein the expected subscriber population is used to automatically adjust the estimated subscriber load.

2. The method of claim 1, wherein each of the performance metrics, quality of experience metrics, and financial metrics are associated with configurable algorithms, wherein the configurable algorithms have interdependent variables, and wherein said method simultaneously and automatically solves the algorithms.

3. The method of claim 1, further comprising:
receiving a user specified adjustment for an input that is directly associated with at least one of the performance metrics, the quality of experience metrics, and the financial metrics; and
responsive to user specified adjustment, automatically and dynamically adjusting values for each of the performance metrics, the quality of experience metrics, and the financial metrics, whereby user specified adjustments related to performance quality of experience, or finance automatically alters values for not metrics not explicitly related to the user specified adjustment.

4. The method of claim 1, further comprising:
establishing constraints for the performance metrics, the quality of experience metrics, and the financial metrics, wherein solutions from the computing, determining, and calculating steps are constrained by the established constraints.

5. The method of claim 1, wherein the steps of the method are performed to forecast an effect of a proposed change to the information technology infrastructure.

6. The methods of claim 1, wherein the steps of the method are performed to adaptively optimize an operational environment in which the information technology infrastructure is operationally providing the least one service.

7. The method of claim 1, wherein the at least one service comprises a plurality of services, each of which contributes to the performance metrics, the quality of experience metrics, and the financial metrics.

8. The method of claim 7, wherein each of the plurality of services is selectively enabled by a user within a software tool, and where different values for the computing, determining, and calculating steps result depending on which ones of the plurality of services have been selectively enabled.

9. The method of claim 7, wherein the information technology infrastructure includes a telecommunications infrastructure, and wherein the plurality of services include at least one of an Internet protocol television (IPTV) service and a video on demand (VOD) service.

10. The method of claim 9, wherein the plurality of services include at least one of an Internet service and a telephone service.

11. The method of claim 1, wherein said steps of claim 1 are steps performed by at least one machine in accordance with at least one computer program having a plurality of code sections that are executable by the least one machine.

12. The method of claim 1, wherein the steps of claim 1 are performed by at least one of a service agent and a computing device manipulated by the service agent, the steps

13. A software tool for analyzing an information technology infrastructure comprising:
an infrastructure performance component configured to compute performance metrics experienced for an identified technology infrastructure that is operating under an identified load;
a quality of experience component configured to determine quality of experience metrics experience by subscribers of at least one identified service provided over the information technology infrastructure based at least in part upon the computed performance metrics; and
a finance component configured to calculate financial metrics based in part upon a subscriber population that varies in accordance with the quality of experience metrics, whereby the identified load is dynamically adjusted in accordance with the subscriber population.

14. The software tool of claim 13, wherein constraints are established for each of the performance component, the quality of experience component, and the finance component, wherein the software tool automatically determines solutions for each of the components that satisfies the established constraints.

15. The software tool of claim 13, further comprising:
an adjustment interface configured to permit a user to select one of the components and to specify adjustments of the selected component, wherein the software tool automatically and dynamically adjusts metrics for the non-selected components responsive to the specified adjustments.

16. The software tool of claim 13, wherein the identified information technology infrastructure is a simulated infrastructure built with a software simulation tool.

17. The software tool of claim 13, wherein the at least one identified service includes at least one of an Internet protocol television (IPTV) service and a video on demand (VOD) service.

18. The software tool of claim 13, wherein the at least one identified service comprises a plurality of services, wherein the quality of experience component determines different quality of experience metrics for each of the plurality of services, wherein the finance component calculates different subscriber populations for each of the plurality of services, and wherein the performance metrics are based upon the identified load resulting from the plurality of services provided to the calculated subscriber populations.

19. The software method for planning a digital network comprising:
developing a performance model based upon an identified information technology infrastructure and an identified tool;
developing a quality of experience model, wherein at least one formula used to construct the quality of experience model is a function of a service delivered to at least one subscriber via the infrastructure under the identified load, wherein metrics from the performance model are used to solve the at least one formula of the quality of experience model;
developing a finance model, wherein the finance model is based upon a subscriber population for the service, wherein the finance model adjusts the subscriber population in accordance with a blocking probability, which is dependent upon quality of experience metrics generated by quality of experience model;
identifying constraints for each of the performance model, the quality of experience model, and the finance model; and
automatically determining at last one solution that concurrently satisfies the identified constraints.

20. The method of claim 19, further comprising:
receiving a user selection of one of the models;
receiving a user specified adjustment of the selected model;
responsive to user specified adjustment, automatically and dynamically adjusting values of non-selected ones of the models.
